(19) United States
(12) Patent Application Publication
(10) Pub. No.: US 2013/0269251 A1
(43) Pub. Date: Oct. 17, 2013

(54) SYSTEM AND METHOD FOR CHANGING PUMPS FOR FEEDSTOCK SUPPLY SYSTEM

(71) Applicants: Ronald Frederick Tyree, Houston, TX (US); Chris Joseph Villa, Houston, TX (US)

(72) Inventors: Ronald Frederick Tyree, Houston, TX (US); Chris Joseph Villa, Houston, TX (US)

(73) Assignee: GENERAL ELECTRIC COMPANY, Schenectady, NY (US)

(21) Appl. No.: 13/449,281

(22) Filed: Apr. 17, 2012

(51) Int. Cl. B01J 7/00; F17D 1/00; E03B 11/16

(52) U.S. Cl. 48/61; 137/565.01; 137/2

(57) ABSTRACT

A system including a feedstock supply system that includes a first pump configured to supply a first feedstock to a first gasifier along a first supply conduit, a second pump configured to supply a second feedstock to the first gasifier along a second supply conduit, and a pressure vessel disposed along a first conduit loop. The feedstock supply system is configured to circulate the first feedstock through the first conduit loop to raise a first pressure of the first feedstock to a first threshold pressure in the pressure vessel. The feedstock supply system is also configured to control a first transition from the second pump to the first pump after the first pressure reaches the first threshold pressure. The first transition includes a first change from the second feedstock to the first feedstock for supply to the first gasifier.

### BACKGROUND OF THE INVENTION

The subject matter disclosed herein relates to gasification systems, and, more particularly, to feedstock supply systems and methods.

Gasifiers convert carbonaceous materials into a mixture of carbon monoxide and hydrogen, referred to as synthesis gas or syngas. For example, a power plant may include one or more gasifiers that react a feedstock at a high temperature with oxygen and/or steam to produce syngas, which may be treated prior to use as a fuel. As will be appreciated, providing the gasifier with a substantially uniform, constant, and homogeneous distribution of gas and feedstock particles enhances efficiency and stability of the syngas conversion process. Non-uniform or inconsistent feedstock supply to a gasifier may lead to increased wear or undesirable gasifier conditions leading to gasifier shutdown. Unfortunately, gasifiers may also shut down due to sudden or planned maintenance to feedstock supply systems.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system including a feedstock supply system that includes a first pump configured to supply a first feedstock to a first gasifier along a first supply conduit, a second pump configured to supply a second feedstock to the first gasifier along a second supply conduit, and a pressure vessel disposed along a first conduit loop. The feedstock supply system is configured to circulate the first feedstock through the first conduit loop to raise a first pressure of the first feedstock to a first threshold pressure in the pressure vessel. The feedstock supply system is also configured to control a first transition from the second pump to the first pump after the first pressure reaches the first threshold pressure. The first transition includes a first change from the second feedstock to the first feedstock for supply to the first gasifier.

In a second embodiment, a system includes a feedstock supply controller configured to control feedstock supply to a first gasifier. The feedstock supply controller is configured to control a first flow of a first feedstock from a first pump to the first gasifier along a first supply conduit, to control a second flow of a second feedstock from a second pump to the first gasifier along a second supply conduit, to control circulation of the first feedstock through a first conduit loop having a pressure vessel to raise a first pressure of the first feedstock to a first threshold pressure in the pressure vessel, and to control a first transition from the second pump to the first pump after the first pressure reaches the first threshold pressure. The first transition includes a first change from the second feedstock to the first feedstock for supply to the first gasifier.

In a third embodiment, a method includes controlling a first flow of a first feedstock from a first pump to a first gasifier along a first supply conduit, controlling a second flow of a second feedstock from a second pump to the first gasifier along a second supply conduit, controlling circulation of the first feedstock through a first conduit loop having a pressure vessel to raise a first pressure of the first feedstock to a first threshold pressure in the pressure vessel, and controlling a first transition from the second pump to the first pump after the first pressure reaches the first threshold pressure. The first transition includes a first change from the second feedstock to the first feedstock for supply to the first gasifier.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic block diagram of an embodiment of an integrated gasification combined cycle (IGCC) power plant utilizing a transitional feedstock supply system to supply one or more feedstocks to a gasifier;

FIG. 2 is a schematic block diagram of an embodiment of a transitional feedstock supply system configured to supply one or more feedstocks to multiple gasifiers;

FIG. 3 is a schematic diagram of an embodiment of the operation of the transitional feedstock supply system;

FIG. 4 is a flow chart of an embodiment of a process of operating the transitional feedstock supply system; and

FIG. 5 is a chart of an embodiment of the flow rate over time of two pumps during operation as shown in FIG. 4.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

A feedstock supply system may supply a feedstock to a downstream system (e.g., reactor, gasifier, boiler). Embodiments of the present disclosure include the feedstock supply system, which may have two or more pump trains (e.g., pumps, conduits, reservoirs, valves, etc.). Each pump train may be configured to supply one or more feedstocks to the downstream system or systems. For example, a first pump train may supply a first feedstock and a second pump train may supply the first feedstock and/or a second feedstock. The transitional feedstock supply system may transition from supplying the downstream system with feedstock from the first pump train to feedstock from the second pump train, while maintaining substantially steady operation of the downstream system. For example, a controller may bring the second pump train offline and the first pump train online while maintaining a substantially constant feedstock flow rate and feedstock pressure into the downstream system. The transitional feedstock supply system may utilize a pressure vessel and a controller to transition between the pump trains. For example, the controller may progressively increase the flow rate of the first feedstock from the first pump train and progressively decrease the flow rate of the second feedstock from the second pump train. In some embodiments, the downstream system may receive a substantially constant total feedstock flow rate that includes the decreasing flow rate of the second feedstock and a portion of the increasing flow rate of the first feedstock. In this embodiment, the pressure vessel may also receive a portion of the first feedstock while the flow rate of the first pump train is increasing. The transitional feedstock supply system may include a plurality of pump trains to provide a plurality of pump trains and/or a plurality of feedstocks that may be transitioned to for maintenance or performance reasons. Changing the pump train that supplies the feedstock without interrupting the operation of the downstream system may be desirable for several reasons. For example, one pump train may be taken offline for maintenance (e.g., scheduled or unscheduled), but the downstream system may remain online because another pump train was brought online to supply the downstream system. The plurality of pump trains may also permit the downstream system to transition from one feedstock supply to another (e.g., for cost, availability, or performance reasons). For example, the first pump train may supply a coal slurry feedstock and the second pump train may supply agricultural waste. A controller may direct the first pump to supply the coal slurry feedstock at startup of the downstream system and then transition to supply the agricultural waste after a startup period.

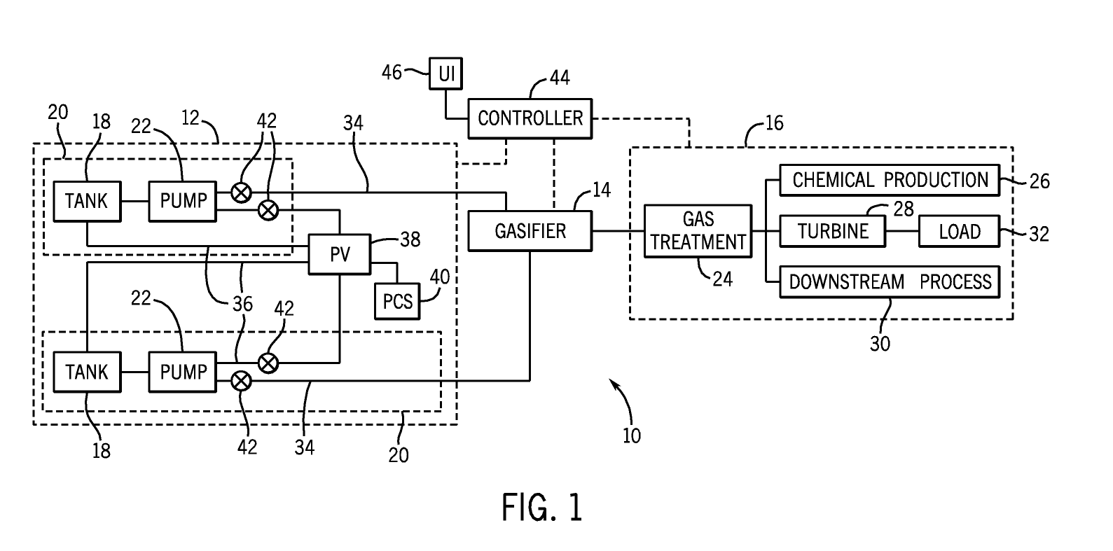

FIG. 1 is a diagram of an embodiment of an integrated gasification combined cycle (IGCC) system 10 utilizing a transitional feedstock supply system 12 to supply a downstream system (e.g., gasifier 14). The IGCC system 10 produces and burns a synthetic gas, i.e., syngas, to generate electricity. Elements of the IGCC system 10 may include a transitional feedstock supply system 12, a gasifier 14, and gas utilization systems 16. IGCC systems 10 may utilize many fuel sources, including coal, petroleum coke, biomass, wood-based materials, agricultural wastes, tars, asphalt, or other carbon containing items. The transitional feedstock supply system 12 may store at least one fuel source in one or more feedstock supply chambers 18, such as slurry tanks, hoppers, or other reservoirs. Solid fuels may be processed, for example resized or reshaped, by chopping, milling, shredding, pulverizing, briquetting, or pelletizing to generate feedstock. Additionally, water, or other suitable liquids may be added to the fuel source to create slurry feedstock. In other embodiments, no liquid is added to the fuel source, thus yielding dry feedstock.

The transitional feedstock supply system 12 may include a plurality of pump trains 20. Each pump train 20 may have a feedstock supply chamber 18, a pump 22, and a supply conduit 34. Each pump train 20 may pass the feedstock from the feedstock supply chamber 18 (e.g., slurry tank) through a pump 22 and supply conduit 34 to the gasifier 14. The gasifier 14 may convert the feedstock into a syngas, e.g., a combination of carbon monoxide and hydrogen. This conversion may be accomplished by subjecting the feedstock to a controlled amount of steam and oxygen at elevated pressures, e.g., from approximately 2 MPa to 11 MPa, and temperatures, e.g., approximately 700° C. to 1600° C., depending on the type of gasifier 14 utilized. The gasification process may include the feedstock undergoing a pyrolysis process, whereby the feedstock is heated. Temperatures inside the gasifier 14 may range from approximately 150° C. to 700° C. during the pyrolysis process, depending on the fuel source utilized to generate the feedstock. The heating of the feedstock during the pyrolysis process generates a solid, (e.g., char), and residue gases, (e.g., carbon monoxide, hydrogen, and nitrogen). The char remaining from the feedstock from the pyrolysis process may only weigh up to approximately 30 percent of the weight of the original feedstock.

A partial oxidation process also occurs in the gasifier 14. The oxidation process may include introducing oxygen to the char and residue gases. The char and residue gases react with the oxygen to form carbon dioxide and carbon monoxide, which provides heat for the gasification reactions. The temperatures during the partial oxidation process may range from approximately 700° C. to 1600° C. Steam may be introduced into the gasifier 14 during gasification. The char may react with the carbon dioxide and steam to produce carbon monoxide and hydrogen at temperatures ranging from approximately 800° C. to 1100° C. In essence, the gasifier utilizes steam and oxygen to allow some of the feedstock to be “burned” to produce carbon monoxide and release energy, which drives a second reaction that converts further feedstock to hydrogen and additional carbon dioxide.

In this way, a resultant gas is created by the gasifier 14. This resultant gas may include approximately 85 percent of carbon monoxide and hydrogen in equal proportions, as well as CH₄, HCl, HF, COS, NH₃, HCN, and H₂S (based on the sulfur content of the feedstock). This resultant gas may be termed untreated, raw, or sour syngas, since it contains, for example, H₂S. The gasifier 14 may also generate waste, such as slag. A gas treatment unit 24 of a gas utilization system 16 may scrub the raw syngas to remove the HCl, HF, COS, HCN, and H₂S from the raw syngas by, for example, an acid gas removal process. Furthermore, the gas treatment unit 24 may separate salts from the raw syngas. Subsequently, the gas from the gas treatment unit 24 may include treated, sweetened, and/or purified syngas, (e.g., the sulfur has been removed from the syngas), with trace amounts of other chemicals, e.g., NH₃ (ammonia) and CH₄ (methane). This treated syngas may then be transmitted to a chemical production system 26, gas turbine system 28, or downstream process 30. For example, syngas from the gas treatment unit 24 may be transmitted to a combustor chamber of a gas turbine system 28 in order to drive a load 32 (e.g., electrical generator).

The transitional feedstock supply system 12 may include a plurality of pump trains 20 (e.g., 2, 3, 4, 5, 6, or more) configured to supply a feedstock to the gasifier 14 along a respective plurality of supply conduits 34. Each pump 22 of a pump train 20 may be configured to pump a feedstock from a feedstock supply chamber 18 along a supply conduit 34 to the gasifier 14. Each pump 22 may also be configured to pump the feedstock along a conduit loop 36, through a pressure vessel 38, and back to a feedstock supply chamber 18. The feedstock supply chamber 18 may be along the conduit loop 36 upstream of the pump 22. In some embodiments, a common feedstock supply chamber 18 may be upstream of multiple pumps 22. In other embodiments, each pump 22 may have a separate feedstock supply chamber 18 upstream of the respective pumps 22. In some embodiments, the conduit loop 36 includes at least part of the supply conduit 34. As described in detail below, a pressure control system 40 may be coupled to the pressure vessel 38 to regulate the flow of feedstock into the pressure vessel 38 and the pressure within the pressure vessel 38. In some embodiments, each supply conduit 34 and conduit loop 36 may have at least one valve 42 controlled by a controller 44 to regulate flow through the supply conduit 34 and conduit loop 36. The controller 44 may include a processor, memory, and code or instructions stored in the memory to control aspects of the system 10 as discussed below. The controller 44 may also include a user interface 46 configured to at least receive input (e.g., pump instructions, valve instructions, scheduled shut down time of pump train 20) from a user or display system information (e.g., temperature, pressure, flow rate, pump train operation, valve position, feedstock level, duration of operation, etc.). For example, the controller 44 may close the valves 42 of a supply conduit 34 and control a feedstock along a conduit loop 36. The controller 44 may also control the operation of each pump 20. For example, the controller 44 may control only one pump 20 to supply feedstock to each gasifier 14 except during a transition of the supply of feedstock to another pump 20. During this transition, two pumps 20 may supply feedstock to a gasifier 14 as one pump 20 progressively increases the feedstock supply and the other pump 20 progressively decreases the feedstock supply. In some embodiments, the controller 44 may also control the pressure control system 40. The controller 44 may control the pressure control system 40 to raise pressure to a threshold pressure based on a pressure of a downstream system (e.g., gasifier 24). In an embodiment, the threshold pressure may be substantially the same pressure as the downstream system before the transition. The controller 44 may also be coupled to and control the gasifier 14 and/or gas utilization system 16.

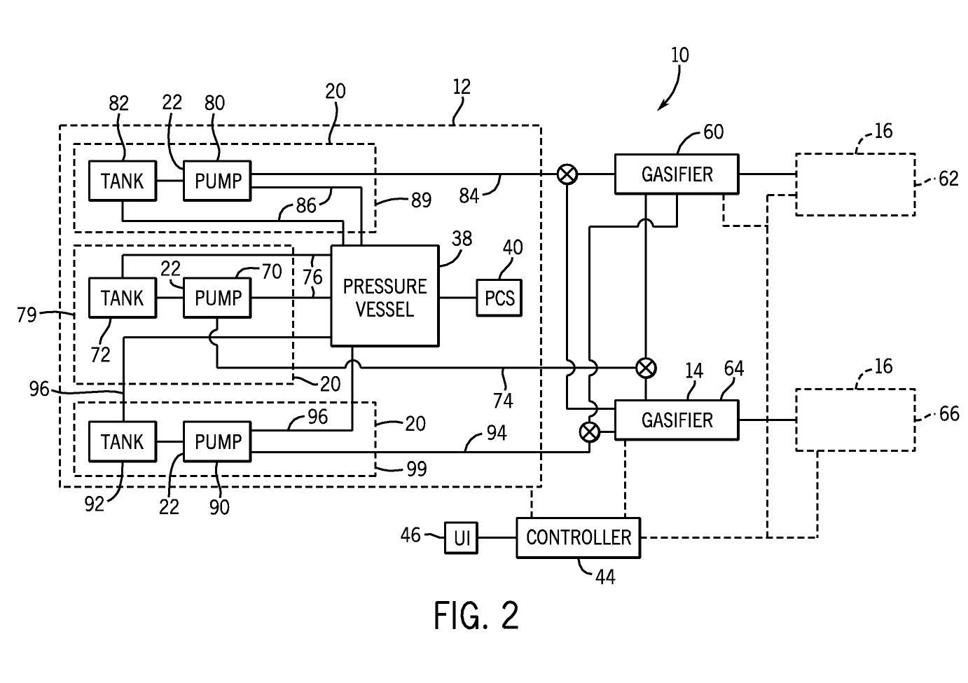

As illustrated in FIG. 2, the IGCC system 10 may include a plurality of gasifiers 14 (e.g., 2 or more) and the feedstock supply system 12 may include a plurality of pump trains 20 (e.g., 3 or more). In an embodiment, a first gasifier 14, 60 may supply syngas to a first 62 gas utilization system 16, and a second gasifier 14, 64 may supply syngas to a second 66 gas utilization system 16. In some embodiments, the first 60 and second 64 gasifiers may supply syngas to the same gas utilization system 16. The transitional feedstock supply system 12 is not limited to supplying feedstock to just one or two gasifiers 14, but some embodiments may supply feedstock to any number of gasifiers 14 or gas utilization systems 16. For example, other IGCC systems 10 may include 2, 3, 4, 5, 6, 7, 8, 9, 10 or more gasifiers 14 and 2, 3, 4, 5, 6, 7, 8, 9, 10 or more gas utilization systems 16, or any combination thereof.

The transitional feedstock supply system 12 may include a plurality of pump trains 20 to supply feedstock to the plurality of gasifiers 14. In some embodiment as shown in FIG. 2, the transitional feedstock supply system 12 includes a first pump 70 and a first feedstock supply chamber 72 of a first pump train 79, a second pump 80 and a second feedstock supply chamber 82 of a second pump train 89, and a third pump 90 and a third feedstock supply chamber 92 of a third pump train 99. Each pump 70, 80, and 90 may supply the same or different feedstocks to the first 60 and second 62 gasifiers 14. In some embodiments, the first feedstock supply chamber 72 may be the same as the second feedstock supply chamber 82 and/or the third feedstock supply chamber 92. In other words, a common feedstock supply chamber 18 may be shared among the pump trains 79, 89, and/or 99. In an embodiment, the first pump 70 may be configured to supply a first feedstock through a first supply conduit 74 to the first gasifier 60 and/or the second gasifier 64, the second pump 80 may be configured to supply a second feedstock through a second supply conduit 84 to the first gasifier 60 and/or the second gasifier 64, and the third pump 90 may be configured to supply a third feedstock through a third supply conduit 94 to the first gasifier 60 and/or the second gasifier 64. In some embodiments, each pump train 79, 89, 99 may be configured to supply a respective feedstock to the first 60 or second 64 gasifier. In certain embodiments, each gasifier 14 may receive a feedstock from only one pump train 20 at a time except when transitioning between pump trains 20 as described in detail below. Each pump 70, 80, and 90 may also be configured to circulate its respective feedstock through the pressure vessel 38 along a first conduit loop 76, a second conduit loop 86, and a third conduit loop 96 respectively. Thus, the pressure vessel 38 may be disposed along the first conduit loop 76, the second conduit loop 86, and/or the third conduit loop 96. In some embodiments, there may be more than one pressure vessel 38, and each pressure vessel 38 may be along one or more conduit loops 36 that include a pump 22 and a feedstock supply chamber 18. A pressure control system 40 may be coupled to the pressure vessel 38 to regulate pressure and flow in the pressure vessel 38.

The controller 44 may control feedstock flow through the transitional feedstock supply system 12 to direct a feedstock flow to the pressure vessel 38. Within the pressure vessel 38, the pressure control system 40 may raise the pressure of the feedstock to a threshold pressure, which may be based at least in part on a pressure of a downstream system (e.g., gasifier 14) for which the controller 44 is transitioning between feedstocks and/or pump trains 20. In some embodiments, the controller 44 may control a transition of a feedstock supply to a downstream system from a first feedstock to the feedstock within the pressure vessel 38 after the pressure within the pressure vessel 38 is substantially (e.g., ±1, 2, 3, 4, or 5 percent) the threshold pressure.

The number of pumps 22 in the transitional feedstock supply system 12 may vary between embodiments. In some embodiments, each pump 22 may supply feedstock to one or more gasifiers 14. In certain embodiments, the transitional feedstock supply system 12 may include at least one more pump 22 than the number of gasifiers 14 of the IGCC system 10. For example, the pump/gasifier ratio may include, but is not limited to 2:1, 3:2, 4:3, or 5:4. The pumps 22 of the transitional feedstock supply system 12 may be redundantly configured to supply a feedstock to the one or more gasifiers 14 to permit one or more pumps 22 to be taken offline while maintaining continuous operation of the one or more gasifiers 14. In this manner, the redundantly configured pumps 22 may be transitioned to alternately supply a continuous and steady feedstock supply to one or more gasifiers 14 as needed when other pumps 22 are shut down. As each pump 22 may be part of a pump train 20, the pump trains 79, 89, 99 may also be redundantly configured to permit pump trains 79, 89, 99 to be alternately taken offline as another pump train comes online. For example, a transitional feedstock supply system 12 having three pump trains 79, 89, 99 may be configured to supply feedstock to two gasifiers 60, 64. Initially, the second pump train 89 may supply the first gasifier 60 and the third pump train 99 may supply the second gasifier 64. The system 12 may transition to change the supply of the first gasifier 60 from the second pump train 89 to the first pump train 79. When the second pump train 89 is operable again, the system 12 may transition to change the supply of the second gasifier 64 from the third pump train 99 to the second pump train 89. Similarly, when the third pump train 99 is operable again, the system 12 may transition to change the supply of the first gasifier 60 from the first pump train 79. Each of the plurality of pump trains 20 may be redundantly configured with the pressure vessel 38 and pressure control system 40 to circulate a respective feedstock into the pressure vessel 38 to raise the pressure of the respective feedstock to a threshold pressure for a transition to supply the respective feedstock to a downstream system (e.g., gasifier 14) in place of another pump train 20. Thus, the system 12 may change among feedstocks supplied to gasifiers 14 or pump trains 20 in operation without interrupting operation of the gasifiers 14.

As discussed in detail below, the controller 44 of an IGCC system 10 with more pump trains 20 or pumps 22 than gasifiers 14 may conveniently transition a feedstock supply between pump trains 20 or pumps 22 without shutting down a gasifier 14. For example, the controller 44 may transition the supply to the first gasifier 60 from the second feedstock supply of the second pump 80 to the first feedstock supply of the first pump 70 while maintaining the third feedstock supply of the third pump 90 to the second gasifier 64. In a similar manner, the controller 44 may transition to supply the second gasifier 64 from the third feedstock supply of the third pump 90 to the first feedstock supply of the first pump 70 while maintaining the second feedstock supply of the second pump 80 to the first gasifier 60. The controller 44 may also include a user interface 46 configured to at least receive input from a user or display information about the IGCC system 10.

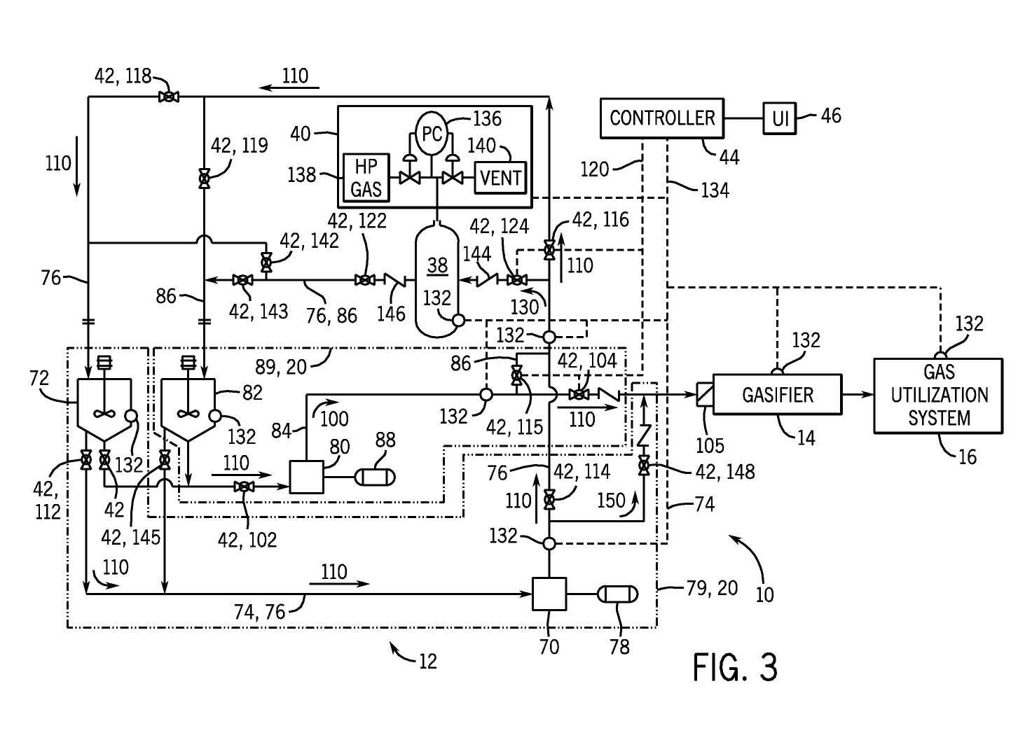

FIG. 3 illustrates an embodiment of a transitional feedstock supply system 12 having a first pump 70 and a second pump 80. The pumps 70, 80 may be positive displacement pumps, slurry pumps, or centrifugal pumps. A first pump train 79 includes the first pump 70, the first feedstock supply chamber 72, the first feedstock supply conduit 74, the first loop conduit 76, and a first motor 78 drivingly coupled to the first pump 70. A second pump train 89 includes the second pump 80, the second feedstock supply chamber 82, the second feedstock supply conduit 84, the second loop conduit 86, and a second motor 88 drivingly coupled to the second pump 80. The controller 44 may monitor the operation transitional feedstock supply system 12, including the first pump 70 and first motor 78, the second pump 80 and second motor 88, the status (e.g., open/closed) of a plurality of valves 42, the pressure and flow rate of feedstock within the supply conduits 74 and 84, the pressure and flow rate of feedstock within the conduit loops 76 and 86 (including the pressure vessel 38), the pressure within the gasifier 14, the fuel/air ratio in the gasifier, and combinations thereof In this embodiment, the second pump 80 may pump a second feedstock from the second feedstock supply chamber 82 along the second supply conduit 84 to the gasifier 14 as shown by arrows 100, while the valves 102 and 104 are open along the second supply conduit 84. In an embodiment, the second supply conduit 84 may lead to multiple outlets (e.g., injectors 105) to the gasifier 14. The second pump 80 may be driven by the second motor 88 or other drive mechanism. At an initial stage, only the second pump 80 may be in operation supplying the gasifier 14 with the second feedstock. The gasifier 14 may process the feedstock at a gasifier pressure within the gasifier 14. The second pump 80 may supply the second feedstock to the gasifier 14 at a second pressure that is substantially the same as (or greater than) the gasifier pressure. This may block backflow from the gasifier 14 to the transitional feedstock supply system 12.

During operation of the second pump 80, an event may cause the controller 44 to begin a transition to change from supplying the gasifier 14 with the feedstock from second pump train 89 to supplying the gasifier 14 with the feedstock from the first pump train 79. In some embodiments, events may be scheduled, such as routine maintenance or transitioning from the second feedstock to the first feedstock. In certain embodiments, events may be unscheduled. Unscheduled events may include, but are not limited, to sensed flow irregularities, sensed changes in feedstock quality, sensed pressure drops or surges, flow blockages or low feedstock levels in the second supply chamber 82 or second supply conduit 84, monitored noises by the controller or operator, or component failure. Furthermore, it may be desirable to switch types of feedstock or mix feedstocks for various reasons, such as efficiency of a downstream system (e.g., gasifier, gas utilization system 16), cost, or level of feedstock in a feedstock supply chamber 72 or 82 among others. In some embodiments, an operator may initiate an event through the controller 44 (e.g., using a user interface 46) to begin a transition. Upon occurrence of the event, the controller 44 may initialize the first pump 70 and begin pumping the first feedstock through the first conduit loop 76 as indicated by arrows 110 in a startup stage. Upon startup of the first pump 70, the first feedstock in the first conduit loop 76 may be at a first pressure (e.g., 101 kPa) that is less than the pressure within the gasifier 14 and second pressure (e.g., 11,000 kPa) in the second supply conduit 84. The pressure within the gasifier 14 and second pressure may be in a range between approximately 3,000 kPa to approximately 11,000 kPa, approximately 5,000 kPa to approximately 10,000 kPa, or approximately 7,000 kPa to approximately 9,000 kPa. In an embodiment, the first pump 70 may not supply the first feedstock to the gasifier 14 in the startup stage in order to maintain a steady, substantially constant pressure, and uniform flow of the second feedstock to the gasifier 14 and prevent backflow into the first pump train 79. In the startup stage, the valves 112, 114, 116, and 118 may be opened along the first conduit loop 76 to circulate the first feedstock as shown by arrows 110. The transitional feedstock supply system 12 may have a plurality of valves 42 to control the flow of the at least one feedstock supplied to the at least one downstream system (e.g., gasifier 14). The controller 44 and/or operator may control each valve 42 and pump train 20 to direct each feedstock along a desired flow path. The controller 44 may be coupled to each valve 42 by control lines 120. Only some control lines 120 are illustrated for clarity.

After the first feedstock begins circulating through the first conduit loop 76, the controller 44 may close the valves 116, 118, and 122, and open valve 124 to control the first feedstock as shown by arrows 130 into the pressure vessel 38 in a pressurizing stage. The first pressure of the first feedstock may increase within the pressure vessel 38 as the first feedstock fills the pressure vessel 38. Sensors 132 within the pressure vessel 38, first pump train 79, second pump train 89, first conduit loop 76, second conduit loop 86, gasifier 14, and gas utilization system 16 may monitor the pressure, temperature, and flow rate of the feedstock in each respective component. The controller 44 and/or pressure control system 40 may receive signals from the sensors 132 along sensor lines 134. The pressure control system 40 may regulate the pressure within the pressure vessel 38 through a pressure controller 136 that may inject high pressure gas 138 to increase pressure in the pressure vessel 38 or vent high pressure gas 138 and/or feedstock in the pressure vessel 38 through a vent 140 to reduce pressure in the pressure vessel 38. In some embodiments, the high pressure gas 138 may include nitrogen, helium, argon, and other inert gases. The pressure controller 136 may pressurize the pressure vessel 38 to an initial pressure before the valve 124 is opened. The pressure controller 136 may also open valves 122 and 142 to release excess first feedstock to the first supply chamber 72. In an embodiment with a common supply chamber 82, the pressure controller 136 may open valve 143 to release excess common feedstock to the common supply chamber 82 and valve 145 may be open to supply the common feedstock to the first pump 70. In some embodiments, the controller 44 is the pressure controller 136. In some embodiments, the pressure vessel 38 may be coupled to check valves 144 and 146 (e.g., one-way valves) to cause feedstock to flow through the pressure vessel 38 in one direction.

When the first pressure in the pressure vessel 38 reaches a first threshold pressure, the controller 44 may open the first gasifier valve 148 along the first supply conduit 74 to permit at least a portion of the first feedstock to flow to the gasifier 14 as shown by arrow 150. The second feedstock from the second pump 80 may continue to flow, at a partially reduced flow rate as shown by arrow 100. In some embodiments, the first threshold pressure of the pressure vessel 38 may be substantially the same as the second pressure of the second feedstock in the second supply conduit 84 and/or the pressure within the gasifier 14. In some embodiments, the gasifier 14 may operate at pressures up to 11 MPa, thus the pressure vessel 38 may raise the pressure of the first feedstock to a first threshold pressure up to at least 11 MPa during the transition stage. In other embodiments, the first threshold pressure may include pressures of approximately 1, 2, 3, 4, 5, 6, 7, 8, 9, 10 MPa or more. In this transition stage, introducing the first feedstock at the first threshold pressure to the gasifier 14 may substantially block backflow of the second feedstock into the first supply conduit 74, backflow of the first feedstock into the second supply conduit 84, pressure surges into the gasifier 14, and combination thereof. As the controller 44 opens the first gasifier valve 148, the controller 44 may also slow the operation of the second pump 80 and/or restrict the flow of the second feedstock through the second gasifier valve 104. Slowing the operation of the second pump 80 may cause less wear to the second pump train 89 than restricting the flow through the second gasifier valve 104.

In the transition stage, the controller 44 may progressively decrease the flow of the second feedstock along arrows 100 and progressively increase the flow of the first feedstock along arrows 150 to substantially maintain a constant flow rate of feedstock to the gasifier 14. For example, during the initial stage, the second pump 80 may supply the second feedstock to the gasifier 14 at an initial flow rate of approximately 100 tons/hour. During the pressurization stage, the first pump 70 may pump the first feedstock to the pressure vessel 38 at approximately 30 tons/hour. When the controller 44 opens the first gasifier valve 148, the controller 44 may also adjust the operation of the second pump 80 to supply the second feedstock at approximately 70 tons/hour to substantially maintain the flow rate of 100 tons/hour. In some embodiments, the first 70 and second 80 pumps may supply respective feedstocks at flow rates between approximately 10 to 200 tons/hour, approximately 20 to 175 tons/hour, approximately 30 to 150 tons/hour, approximately 40 to 125 tons/hour, or approximately 50 to 100 tons/hour. The controller 44 may adjust operation of the first 70 and second 80 pumps to affect a gradual transition from the second pump 80 to the first pump 70. The first pump 70 pumps feedstock at a first flow rate and the second pump 80 pumps feedstock at a second rate. The controller 44 directs the mixing of the first and second flow rates to sum to a desired flow rate as they flow to the gasifier 14. During the transition, the sum of the first and second flow rates may be greater than the desired flow rate. For example, the first flow rate may be 20 tons/hour, the second flow rate may be 90 tons/hour, and the desired flow rate may be 100 tons/hour. The controller 44 may direct 10 tons/hour of the first flow rate to the pressure vessel 38 and mix the remaining 10 tons/hour with the second flow rate (90 tons/hour) to meet the desired flow rate (100 tons/hour). During the transition, the controller 44 may simultaneously decrease the second flow rate, increase the first flow rate to maintain the desired flow rate, and direct any surplus of the first flow rate to the pressure vessel 38. The controller 44 may also direct feedstock from the pressure vessel 38 to the first feedstock supply chamber 72 along the first supply conduit 74 to be circulated through the first pump 70. Thus, the pressure vessel 38 may increase the pressure of feedstock and receive surplus feedstock during a transition to maintain a substantially constant flow rate to the gasifier 14.

As describe above, the controller 44 may transition a feedstock supply to a gasifier 14 from the second pump train 89 to the first pump train 79. After a transition is complete, the transitional feedstock supply system 12 may be configured so that the controller 44 may transition a feedstock supply to a gasifier 14 from the first pump train 79 to the second pump train 89. In an embodiment, the controller 44 may transition from the first pump train 79 back to the second pump train 89 by controlling valve 115 like valve 114 and controlling valve 104 like valve 148 as described above. In this embodiment, the second pump 80 supplies feedstock through the second supply conduit 84 and second conduit loop 86 to the pressure vessel 38 to raise pressure of the pressure vessel 38 to the threshold pressure, and the controller 44 may control valve 119 like valve 118 as described above for the transition back to the second pump 80.

A substantially constant flow rate may permit continuous operation of the gasifier 14 at a steady rate during the transition stage. A substantially constant flow rate may be a flow rate within approximately ±1, 2, 3, 4, or 5 percent of a desired flow rate. In some embodiments, greater flow rates may be permissible where excess flow may be vented and/or flared. Interrupted or unsteady flows may trip a sensor 132 in the gasifier 14, causing the gasifier 14 to shut down. During the transition stage, the controller 44 may progressively increase the first pump 70 flow rate to maintain the flow rate to the gasifier 14 as controller 44 progressively decreases the second pump 80 flow rate. The controller 44 may affect the flow rate of the first 70 and second 80 pumps by adjusting the speed of the first 78 and second 88 electric motors. Decreasing the flow rate of the pump 80 may cause less wear to the pump 80 than the wear to the valve 104 caused by restricting the flow through the valve 104. In some embodiments, the flow rate of the second pump 80 may be manually reduced and the controller 44 may automatically increase the flow rate of the first pump 70 to maintain the constant flow rate.

The controller 44 may monitor and adjust conditions within the IGCC system 10 through numerous sensors 132, actuators, and controls. Sensors 132 may include but are not limited to pressure sensors, flow rate sensors, temperature sensors, position sensors, and feedstock supply chamber gauges. In some embodiments, the controller 44 may monitor the pressure, flow rate, temperature, position of valves, and feedstock supply levels, and combinations thereof, for each pump train 79, 89. The controller 44 may display monitored conditions on a display panel to inform an operator of monitored conditions and to prompt operator action. In some embodiments, the controller 44 may monitor a pump train 79, 89 for unscheduled events.

In some embodiments, the transitional feedstock supply system 12 may transition over several hours. Alternatively, the system 12 may transition over the course of between 5 to 30 minutes. At the end of the transition stage, the controller 44 may stop the flow of the second feedstock from the second pump 80 and close the first loop valve 114 as the controller 44 controls the first pump 70 to supply the first feedstock to the gasifier 14 at the desired flow rate. In some embodiments, the controller 44 may purge the pressure vessel 38 and first conduit loop 76 of the first feedstock for maintenance or in preparation for the next transition. Once the second pump 80 is stopped, the controller 44 may isolate and/or purge (e.g., with an inert purge gas or water) the second pump train 89, including the second pump 80, the second feedstock supply chamber 82, and at least parts of the second supply conduit 84 and second conduit loop 86. After the second pump train 89 is isolated and repaired, and/or cleaned, the controller 44 may be configured to change from the first feedstock supply back to the second feedstock supply to the gasifier 14 in substantially the same manner as the second feedstock supply was changed to the first feedstock supply.

As a result of transitioning the feedstock supply from one pump train 20 to another pump train 20 in response to an event, a pump train 20 may be isolated. Scheduled or forced maintenance of the isolated pump train 20 may not affect operation of the gasifier 14 or require down time of the gasifier 14. Over the course of operation of the transitional feedstock supply system 12, alternately changing the feedstock supply from one pump train (e.g., 89) to another (e.g., 79) may decrease the forced down time of a gasifier 14 by approximately 1 to 10 percent, approximately 1 to 8 percent, or approximately 1 to 5 percent. In an embodiment, redundantly configured first 79 and second 89 pump trains with frequent scheduled down time as described above may be cheaper to operate over time than a single more expensive pump train that may require less down time. Additionally, the first 79 and second 89 pump trains may be configured to switch feed type (i.e., from low sulfur to high sulfur or vice versa) once downstream gas utilization systems 16 are fully operational. For example, at startup of a gas utilization system 16, some feedstocks may provide for better performance at lower temperatures. As another example, some feedstocks may be more available or cheaper than other feedstocks. However, once components of the system 16 are warmed, another feedstock may provide optimal performance.

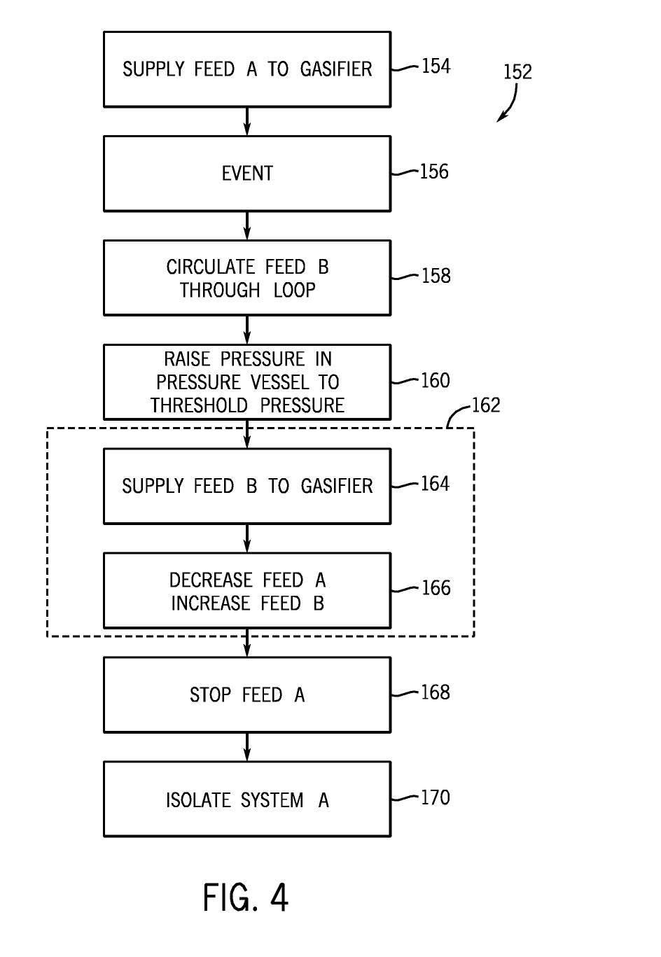

FIG. 4 illustrates a flow chart for a method 152 of operating a transitional feedstock supply system 12 to change from a feed flow A to a feed flow B while maintaining operation of a gasifier 14. The method 152 may be a computer implemented process, such as a process carried out on the controller 44 or other processor-based computing device. The controller 44 may execute the method 152 by way of instructions stored in a memory. In some embodiments, an operator may execute the method 152 through a user interface 46 of the controller 44 as shown in FIG. 1. Initially, a feed pump A may supply 154 a feed flow A along supply conduit A to the gasifier 14. As discussed above, the controller 44 may control the flow rate and pressure of feed flow A from feed pump A. When the controller 44 senses 156 an event has occurred, the controller 44 may control feed pump B to circulate 158 feed flow B along conduit loop B. The conduit loop B may have a pressurization vessel 38, and the controller 44 may direct feed flow B to the pressurization vessel 38 to raise 160 the pressure of feed flow B to a threshold pressure. In an embodiment, the pressurization vessel 38 may include a pressure control 136 coupled to a gas supply 138 and a vent 140 to maintain the pressure of feed flow B. In some embodiments, the threshold pressure may be the pressure in the gasifier 14 and/or the pressure of feed flow A along supply conduit A. Once the pressure of feed flow B reaches the threshold pressure, the controller 44 may transition 162 the gasifier feed from feed flow A of feed pump A to feed flow B of feed pump B. In the transition of feed flows, the controller 44 may direct 164 feed flow B along supply conduit B to the gasifier 14. The controller 44 may also decrease 166 the feed flow A from pump A and increase the feed flow B from pump B simultaneously to substantially maintain a gasifier pressure and flow rate. The controller 44 may stop 168 feed flow A to end the transition 162 when the feed flow B from feed pump B is substantially the desired flow rate. Optionally, the controller may isolate 170 feed pump A and supply conduit A. The method 152 may be applied similarly to transition 162 the gasifier feed from feed flow B to feed flow A when the controller 44 senses 156 a subsequent event, and/or after repair or service to the equipment along feed flow A.

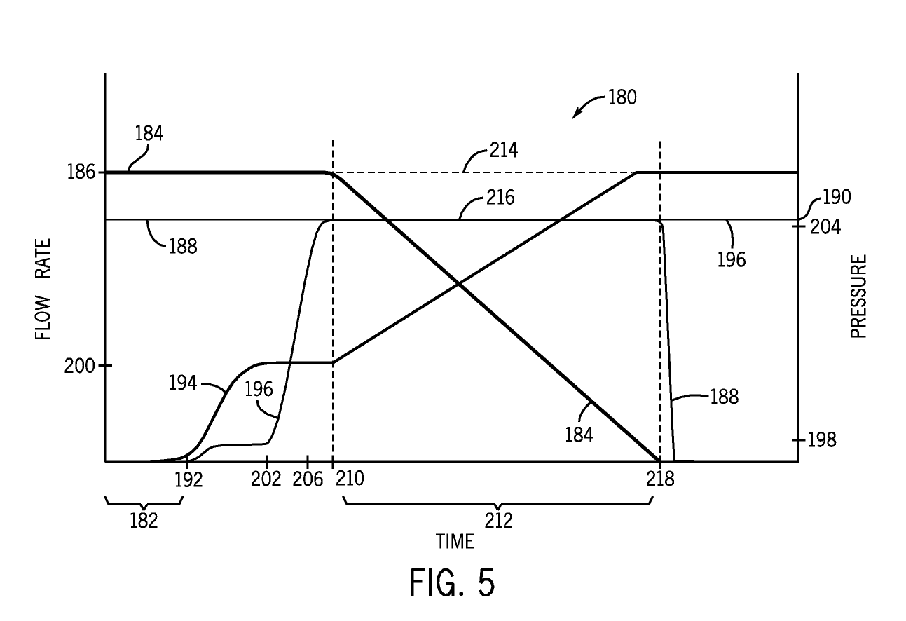

FIG. 5 is a chart 180 of the flow rate over time of an embodiment of a transitional feedstock supply system with a pump A and a redundant pump B. At an initial stage 182, pump A supplies the feedstock A 184 at a first flow rate 186 to a gasifier while pump B is not in operation (i.e., offline). The pressure 188 of feedstock A 184 may be substantially at the gasifier pressure 190. This initial stage 182 may continue until scheduled maintenance or an unscheduled event occurs, as indicated by time 192 on the chart 180. As discussed above, an unscheduled event may include events sensed by a controller such as flow irregularities (e.g., intermittent flow), changes in feedstock quality (e.g., irregular particle size, density, consistency), pressure drops or surges, a low feedstock level in the supply chamber, flow blockages, or component failures. Upon monitoring the event at time 192, the controller may start up pump B to circulate feedstock B 194 through a conduit loop. The pressure 196 of feedstock B during circulation may be an initial pressure 198. The flow rate of feedstock B 194 from pump B may increase to a second flow rate 200 during circulation through the conduit loop.

At a time 202 when pump B begins to circulate feedstock B 194 at the second flow rate 200, the controller may close part of the conduit loop to direct feedstock B 194 into a pressure vessel. The pressure control of the pressure vessel may regulate an increase in the pressure 196 of feedstock B 194 within the pressure vessel by adjusting a flow rate of high pressure gas into the pressure vessel, adjusting a flow rate of gas venting from the pressure vessel, or adjusting the flow rate of feedstock B 194 exiting the pressure vessel. Other pressure control systems may be used to raise the pressure 196 of feedstock B 194, including but not limited to pistons, bladders, or other devices that can be used to increase pressure. After the pressure 196 of feedstock B 194 reaches a threshold pressure 204 at time 206, the controller may direct at least some of feedstock B 194 into the gasifier at time 210. In an embodiment, the threshold pressure 204 may be the same as the gasifier pressure 190 and/or the pressure 188 of feedstock A 184. Alternatively, the threshold pressure 204 may be within approximately 1, 2, 3, 4, or 5 percent of the gasifier pressure 190 or pressure 188 of feedstock A 184. For example, the threshold pressure 204 may be less than 5 percent greater (e.g., 7,350 kPa) than the gasifier pressure 190 of 7,000 kPa, or the relief valves may decrease the gasifier pressure. In some embodiments, a brief drop in gasifier pressure 190 exceeding 300 kPa may cause system instabilities leading to gasifier shut down. Gasifiers at high gasifier pressures 190 (e.g., 11,000 kPa) may be shut down for smaller pressure drops; however, the threshold for shutdown of gasifiers at low gasifier pressures 190 (e.g., 3,000 kPa) may be greater than 300 kPa. During the transition 212, the controller may increase the flow rate of feedstock B 194 from pump B, adjust the amount of feedstock B directed into the gasifier, and decrease the flow rate of feedstock A 184 from pump A into the gasifier. In some embodiments, the controller may direct a fraction of the flow rate of feedstock B 194 into the gasifier, and a remainder of the flow rate of feedstock B 194 through the conduit loop and pressure vessel. During the transition, the pressure control may maintain the pressure 196 of feedstock B 194 in the pressure vessel at the threshold pressure 204. In this way, the controller may maintain a constant flow rate 214 and pressure 216 of the feedstock into the gasifier, while increasing the flow rate of feedstock B 194 and decreasing the flow rate of feedstock A 184. After the time 218 when the flow rate of feedstock A 184 into the gasifier stops and the pressure 188 drops, the controller may isolate pump A and continue to supply the gasifier with the feedstock B 194 from pump B. The transitional feedstock supply system 12 has transitioned the feedstock supply from feedstock A 184 to feedstock B 194. After the transition from feedstock A 184 to feedstock B, the controller may be configured to transition back to feedstock A 184 or to another feedstock. For example, the controller may increase the flow rate of feedstock A 184 from pump A, adjust the amount of feedstock A directed into the gasifier, and decrease the flow rate of feedstock B 194 from pump B into the gasifier in a substantially similar manner as described above in reverse.

Technical effects of the invention include a feedstock supply system and a feedstock supply controller configured to supply at least one feedstock to at least one gasifier, wherein the feedstock supply system may transition to change the supply of feedstock from different pumps of the feedstock supply system while maintaining a substantially constant pressure and constant flow rate of the at least one feedstock to the at least one gasifier. During the transition from supplying a second feedstock from one pump to supplying a first feedstock from another pump, the feedstock supply controller may direct the first feedstock through a conduit loop that may include a pressure vessel to raise the pressure of the first feedstock. Once the pressure of the first feedstock is substantially the same as the pressure of the second feedstock and/or the downstream system (e.g., the gasifier), the feedstock supply controller may progressively decrease the supply of the second feedstock to the gasifier and progressively increase the supply of the first feedstock to the gasifier. The gasifier may be supplied with a flow of feedstock with substantially constant pressure and substantially constant flow rate during the transition. The feedstock supply system may safely transition from supplying one feedstock to supplying another due to a scheduled or unscheduled event.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a feedstock supply system, comprising:
a first pump configured to supply a first feedstock to a first gasifier along a first supply conduit;
a second pump configured to supply a second feedstock to the first gasifier along a second supply conduit; and
a pressure vessel disposed along a first conduit loop, wherein the feedstock supply system is configured to circulate the first feedstock through the first conduit loop to raise a first pressure of the first feedstock to a first threshold pressure in the pressure vessel, the feedstock supply system is configured to control a first transition from the second pump to the first pump after the first pressure reaches the first threshold pressure, and the first transition comprises a first change from the second feedstock to the first feedstock for supply to the first gasifier.

2. The system of claim 1, comprising the first gasifier.

3. The system of claim 1, comprising a first feedstock supply chamber disposed along the first conduit loop upstream from the first pump.

4. The system of claim 3, wherein the first feedstock supply chamber comprises a first slurry tank.

5. The system of claim 1, wherein the pressure vessel is disposed along a second conduit loop, the feedstock supply system is configured to circulate the second feedstock through the second conduit loop to raise a second pressure of the second feedstock to a second threshold pressure in the pressure vessel, the feedstock supply system is configured to control a second transition from the first pump to the second pump after the second pressure reaches the second threshold pressure, and the second transition comprises a second change from the first feedstock to the second feedstock for supply to the first gasifier.

6. The system of claim 5, comprising a first feedstock supply chamber disposed along the first conduit loop upstream from the first pump, and a second feedstock supply chamber disposed along the second conduit loop upstream from the second pump.

7. The system of claim 6, wherein the first feedstock and the second feedstock are substantially the same as one another.

8. The system of claim 1, wherein the feedstock supply system is configured to control the first transition by progressively increasing a first flow of the first feedstock from the first pump to the first gasifier while progressively decreasing a second flow of the second feedstock from the second pump to the first gasifier.

9. The system of claim 1, wherein the feedstock supply system comprises:
a third pump configured to supply a third feedstock to a second gasifier along a third supply conduit, the feedstock supply system is configured to circulate the first feedstock through the first conduit loop to raise the first pressure of the first feedstock to a second threshold pressure in the pressure vessel, the feedstock supply system is configured to control a second transition from the third pump to the first pump after the first pressure reaches the second threshold pressure, and the second transition comprises a second change from the third feedstock to the first feedstock for supply to the second gasifier.

10. The system of claim 1, comprising a pressure control system coupled to the pressure vessel, wherein the pressure control system is configured to increase pressure in the pressure vessel to raise the first pressure of the first feedstock to the first threshold pressure.

11. The system of claim 10, wherein the pressure control system comprises a pressure control coupled to a gas supply and a vent.

12. A system, comprising:
a feedstock supply controller configured to control feedstock supply to a first gasifier, wherein the feedstock supply controller is configured to:
control a first flow of a first feedstock from a first pump to the first gasifier along a first supply conduit;
control a second flow of a second feedstock from a second pump to the first gasifier along a second supply conduit;
control circulation of the first feedstock through a first conduit loop having a pressure vessel to raise a first pressure of the first feedstock to a first threshold pressure in the pressure vessel; and
control a first transition from the second pump to the first pump after the first pressure reaches the first threshold pressure, wherein the first transition comprises a first change from the second feedstock to the first feedstock for supply to the first gasifier.

13. The system of claim 12, wherein the feedstock supply controller is configured to:
control circulation of the second feedstock through a second conduit loop having the pressure vessel to raise a second pressure of the second feedstock to a second threshold pressure in the pressure vessel; and
control a second transition from the first pump to the second pump after the second pressure reaches the second threshold pressure, wherein the second transition comprises a second change from the first feedstock to the second feedstock for supply to the first gasifier.

14. The system of claim 12, wherein the feedstock supply controller is configured to control the first transition by progressively increasing the first flow of the first feedstock from the first pump to the first gasifier while progressively decreasing the second flow of the second feedstock from the second pump to the first gasifier.

15. The system of claim 12, wherein the feedstock supply controller is configured to control a pressure control system of the pressure vessel to increase pressure in the pressure vessel to raise the first pressure of the first feedstock to the first threshold pressure.

16. The system of claim 15, comprising the pressure vessel and the pressure control system.

17. The system of claim 16, comprising the first and second pumps.

18. A method, comprising:
controlling a first flow of a first feedstock from a first pump to a first gasifier along a first supply conduit;
controlling a second flow of a second feedstock from a second pump to the first gasifier along a second supply conduit;
controlling circulation of the first feedstock through a first conduit loop having a pressure vessel to raise a first pressure of the first feedstock to a first threshold pressure in the pressure vessel; and
controlling a first transition from the second pump to the first pump after the first pressure reaches the first threshold pressure, wherein the first transition comprises a first change from the second feedstock to the first feedstock for supply to the first gasifier.

19. The method of claim 18, comprising controlling the first transition by progressively increasing the first flow of the first feedstock from the first pump to the first gasifier while progressively decreasing the second flow of the second feedstock from the second pump to the first gasifier.

20. The method of claim 18, comprising controlling a pressure control system of the pressure vessel to increase pressure in the pressure vessel to raise the first pressure of the first feedstock to the first threshold pressure, wherein the pressure control system comprises a pressure control coupled to a gas supply and a vent.
